(19) United States
(12) Patent Application Publication
(10) Pub. No.: US 2024/0143359 A1
(43) Pub. Date: May 2, 2024

(54) INSTANT CLUSTER DEPLOYMENT FOR VIRTUAL MACHINES

(71) Applicant: VMware, Inc., Palo Alto, CA (US)

(72) Inventors: Arunesh Kumar Pandey, Bothell, WA (US); Alexander Krits, Austin, TX (US); Sahan Bamunavita Gamage, San Jose, CA (US); Derek William Beard, Austin, TX (US)

(21) Appl. No.: 17/974,429

(22) Filed: Oct. 26, 2022

(51) Int. Cl. G06F 9/455

(52) U.S. Cl. CPC G06F 9/45545; G06F 9/45558; G06F 2009/45583; G06F 2009/45595

(57) ABSTRACT

Described herein are systems, methods, and software to deploy instant guest clusters in a computing environment. In one example, a host is configured to initiate startup operations of a first virtual machine and stop the startup operations prior to performing guest customization operations. The host is further configured to, in response to a request for a second virtual machine, initiate the second virtual machine as an instant clone of the first virtual machine and execute the guest customization operations for the second virtual machine based on metadata provided for the second virtual machine, wherein the metadata provides configuration information for the second virtual machine.

### BACKGROUND

In computing environments, virtual machines are deployed to use the physical resources of the underlying host computer (host) more efficiently. The physical resources can comprise processing resources, memory resources, networking resources, storage resources, or some other resource from the host. The virtual machines include an operating system and applications or services that provide the desired operations in the computing environment, wherein the services can comprise containers in some examples. Containers package code and dependencies to operate on a host virtual machine while maintaining an abstracted form of isolation.

However, while virtual machines can more efficiently use the resources in association with a host, difficulties can arise in quickly deploying virtual machines to a desired host. For example, if an administrator desires the deployment of a cloned virtual machine from a first virtual machine, the data for the first virtual machine must first be duplicated prior to initiating the cloned virtual machine. These issues can be compounded when a request is generated to deploy multiple cloned virtual machines, wherein delays are caused by duplicating the data for each of the clones and dedicating processing and memory resources to provisioning the clones.

### OVERVIEW

The technology disclosed herein manages the deployment of guest cluster virtual machines in a computing environment. In at least one implementation, a method includes initiating startup operations of a first virtual machine on a host and stopping the startup operations prior to the first virtual machine executing a guest customization operation. The method further includes, in response to a request for a second virtual machine on the host, initiating the second virtual machine as an instant clone of the first virtual machine and executing the guest customization operation for the second virtual machine based on metadata provided for the second virtual machine, wherein the metadata provides configuration information for the second virtual machine.

In some examples, the configuration information includes networking information for the second virtual machine, including IP addressing information and MAC addressing information. In some examples, the configuration information includes resource requirements, including processor requirements and memory requirements.

### BRIEF DESCRIPTION OF THE DRAWINGS

FIG. 1 illustrates a computing environment to manage the deployment of guest cluster virtual machines according to an implementation.

FIG. 2 illustrates a method of initiating a guest cluster virtual machine according to an implementation.

FIG. 3 illustrates an operational scenario of pausing startup operations in association with a master virtual machine and restart the startup operations at a second guest virtual machine according to an implementation.

FIG. 4 illustrates an operational scenario of deploying multiple guest virtual machines for a cluster according to an implementation.

FIG. 5 illustrates a host computing system to manage the deployment of a guest virtual machine according to an implementation.

### DETAILED DESCRIPTION

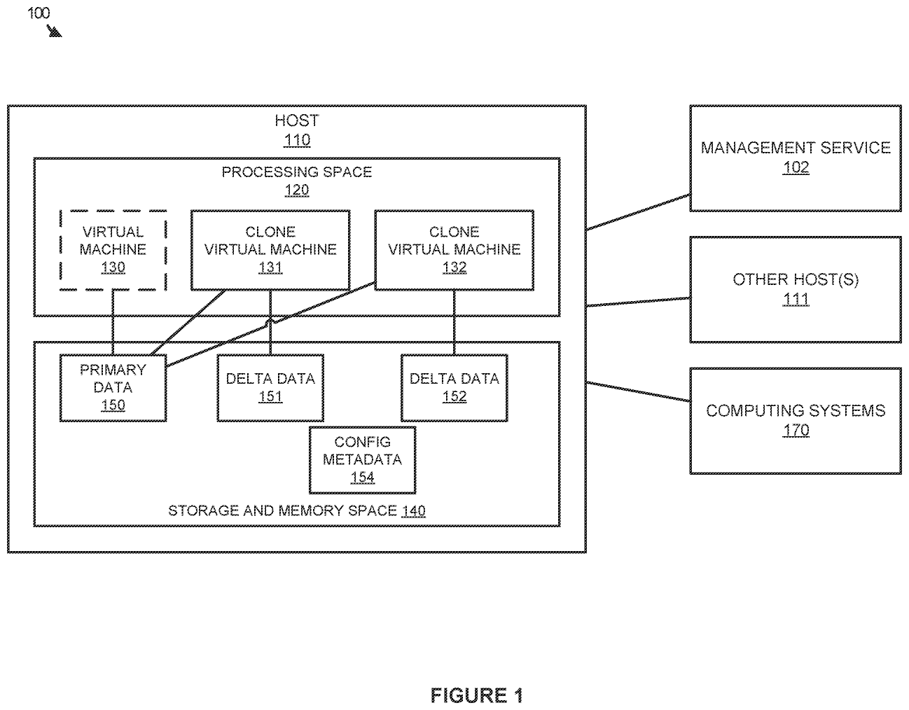

FIG. 1 illustrates a computing environment 100 to manage the deployment of guest cluster virtual machines according to an implementation. Computing environment 100 includes host 110, management service 102, other host(s) 111, and computing systems 170, wherein computing systems 170 may comprise other devices on the same network or available via other networks, such as the internet. Host 110 further includes processing space 120, which can include one or more central processing units (CPUs), and storage and memory space 140, which can comprise storage devices (disk storage, solid-state storage, and the like) and memory. Host 110 can further include networking interfaces or other physical computer elements not illustrated. Storage and memory space 140 includes primary data 150, delta data 151-152, and configuration metadata 154. Processing space 120 comprises processing circuitry that executes virtual machine 130 from primary data 150 and clone virtual machines 131-132 that are derived from primary data 150.

In computing environment 100, host 110 is deployed to provide a platform for virtual machines 130-132. A hypervisor on host 110 can abstract the physical resources of host 110 and provide the abstracted resources to the virtual machines. The abstracted resources can include processor resources, memory resources, networking resources, storage resources, or some other physical resources of the host. Here, a virtual machine 130 is initiated by management service 102 on host 110, wherein virtual machine 130 uses primary data 150. In initiating the startup operations associated with virtual machine 130, one or more virtual disks (or virtual disk files) can be identified for the virtual machine, the disks can be mounted to the virtual machine, data from the disks can be loaded into memory from storage (disk or solid state), or other operations can be performed to initiate virtual machine 130. Typically, additional operations are performed to allocate resources (processor, memory, and the like) and networking information to the virtual machines. These operations can be performed as guest customization operations, wherein guest customization operations can include cloud-init operations for Linux, cloudbase-init for Windows, or some other guest customization operations. The guest customization operations are a software package or packages that perform a variety of tasks, including configuring the host name, installing packages, identifying the IP address and other addressing information for the virtual machine, or other implementing other configuration parameters for the virtual machine. The information can be gathered based at least in part on a metadata file provided for the virtual machine.

Here, prior to implementing the guest customization operations, the configuration of virtual machine 130 is paused or frozen. Thus, prior to execution on host 110, the configuration of virtual machine 130 is stopped without allocating addressing or resources to the virtual machine. The partially configured virtual machine 130 can then be used in association with instant cloned virtual machines 131-132 derived from the partially configured virtual machine 130. An instant cloned virtual machine is an instant copy that uses the same disks and memory state as the parent virtual machine but maintains its own delta disk that corresponds to changes or writes created by the cloned virtual machine. Accordingly, when the startup operations associated with virtual machine 130 are initiated, at least a portion of primary data 150 can be loaded into memory (primary data corresponds to a disk associated with virtual machine 130). In response to a request from management service 102 to initiate clone virtual machine 131, host 110 can link clone virtual machine 131 to the disk and memory space associated with virtual machine 130. Host 110 can then perform the guest customization operations to configure the resources for clone virtual machine 131 and the networking configuration for virtual machine 131. Once configured, clone virtual machine 131 can execute in processing space 120, wherein any changes to primary data 150 can be reflected in delta data 151, which represents a unique delta disk for clone virtual machine 131.

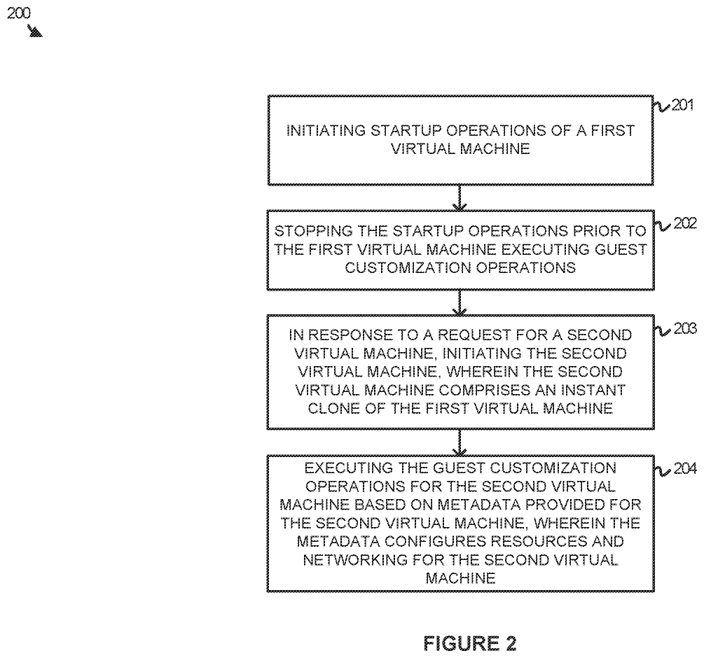

FIG. 2 illustrates a method 200 of initiating a guest cluster virtual machine according to an implementation. The steps of method 200 are referenced parenthetically in the paragraphs that follow with reference to systems and elements of computing environment 100 of FIG. 1. The example below uses the configuration of clone virtual machine 131, however, similar processes can be used in the configuration of clone virtual machine 132.

Method 200 includes initiating (201) startup operations of a first virtual machine. The startup operations can be triggered by a user request, wherein the user can select disks for the virtual machine, software for the virtual machine, or some other information for the virtual machine. The request can further indicate that the virtual machine is to be configured as a master or base that can be replicated to one or more additional virtual machines. The startup operations for the virtual machine can include mounting the required disks to the virtual machine, loading data into memory for the virtual machine, configuring physical resources for the virtual machine, assigning addressing and networking information to the virtual machine, or some other operation. Here, method 200 further provides for stopping (202) the startup operations prior to the first virtual machine executing guest customization operations (e.g., cloud-init, cloudbase-init, etc.), wherein the guest customization operations are used to configure unique portions of the virtual machine, such as the physical resources or networking. Thus, while a portion of the startup operations are completed for the first virtual machine, including allocating and caching a portion of the data in memory, mounting the disks, or some other startup operations, some of the unique configuration operations can be prevented from execution.

Once the startup is paused in association with the first virtual machine, host 110 can wait for a request to generate a second virtual machine as an instant clone of the first virtual machine. An instant clone shares the disks and the memory state allocated to the first virtual machine. In response to the request, method 200 further includes initiating (203) the second virtual machine as the instant clone of the first virtual machine. Referring to the example in computing environment 100, virtual machine 130 can be associated disks and memory represented by primary data 150. In response to a request to generate a clone of virtual machine 130, clone virtual machine 131 is provided with access to primary data 150, such that virtual machine 130 and virtual machine 131 share the same disks and memory state. Additionally, clone virtual machine 131 is allocated a delta disk represented as delta data 151 that stores new or modified data for clone virtual machine 131. Advantageously, rather than creating a new disk and moving the data to memory, multiple virtual machines can share the same storage and memory state from a parent virtual machine.

Once the second virtual machine is initiated, the method further includes executing (204) the guest customization operations for the second virtual machine based on metadata provided for the second virtual machine, wherein the metadata provides configuration information for the second virtual machine. The configuration information can include resource requirement information for the second virtual machine, networking information for the second virtual machine, or some other configuration information supporting a guest cluster for the second virtual machine. For example, the guest customization operations can be used to obtain IP and media access control (MAC) addresses to uniquely address the second virtual machine, can configure processor and memory resources for the individual virtual machine, or can provide some other information in association with the virtual machine.

Although demonstrated as initiating a single virtual machine, a request from an administrator of the computing environment can request multiple virtual machines to provide a cluster in the computing environment. The guest customization operations can be executed for each virtual machine to configure the virtual machine as desired by the administrator. In some examples, while not demonstrated in the example of computing environment 100, multiple master or base virtual machines can be initiated on a host that can then be instant cloned as one or more additional virtual machines. Each of the master or base virtual machines can be stopped prior to executing the guest customization operations, and can support different versions of software, different applications, different disks, or some other different configuration.

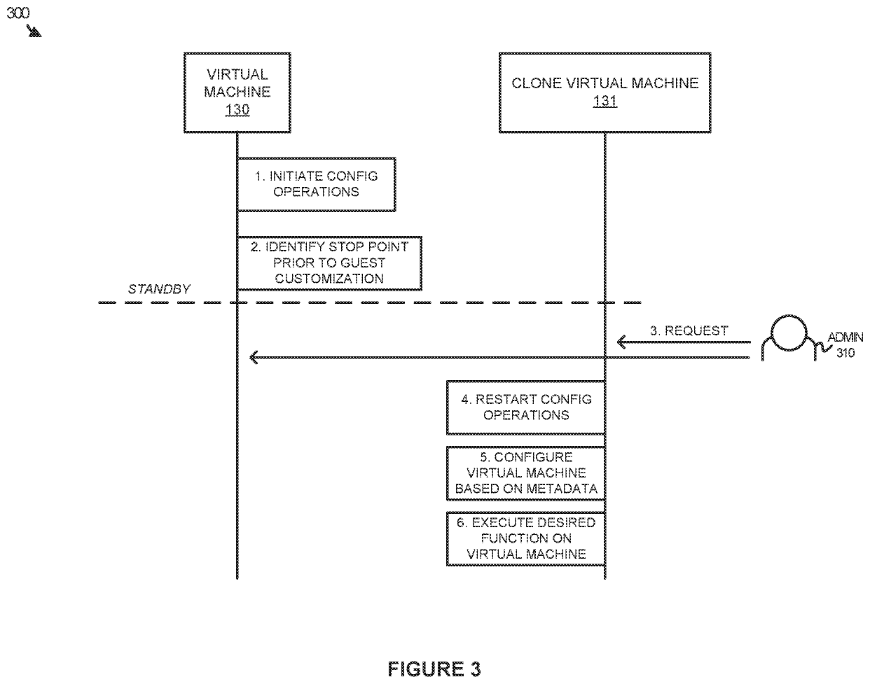

FIG. 3 illustrates an operational scenario 300 of pausing startup operations in association with a master virtual machine and restart the startup operations at a second guest virtual machine according to an implementation. Operational scenario 300 includes virtual machines 130-131 from computing environment 100 of FIG. 1. Operational scenario 300 further includes administrator 310 that is representative of a user capable of requesting a cluster using a base virtual machine 130. Although demonstrated as initiating clone virtual machine 131 from virtual machine 130, similar operations can be performed for other cloned virtual machines on host 110.

In operational scenario 300, host 110 initiates configuration operations associated with virtual machine 130. Virtual machine 130 is used as a master or base virtual machine that can be cloned to produce additional virtual machines that perform desired functions in the computing environment. In some implementations, initiating virtual machine 130 an administrator can indicate disks (disk files) to be made available to the virtual machine. The startup operations can then be used to mount or attach the disks to the virtual machine, load portions of the data from the disks into memory of host 110, or provide some other startup operation. Prior to completing the startup operations, the host further identifies a freeze or stop point prior to implementing guest customization operations for virtual machine 130 at step 2. Guest customization operations can be used to perform a variety of tasks, including obtaining a host name associated with the virtual machine, allocating addressing information in association with the virtual machine, allocating resources to the virtual machine, providing packages to the virtual machine, or some other configuration operation in association with the virtual machine. Once stopped, the virtual machine is used in standby to be cloned as one or more additional virtual machines on the computing system.

Here, administrator 310 generates a request at step 3 to generate an instant clone of virtual machine 130. An instant clone shares the storage and memory space of the original or parent virtual machine, while maintaining a separate delta disk from the parent virtual machine. In response to the request, clone virtual machine 131 is initiate by providing access to the memory and storage associated with virtual machine 130. Once initiated, the configuration operations that were stopped for virtual machine 130 are restarted for clone virtual machine 131 at step 4. The configuration operations will use guest customization operations and metadata provided for clone virtual machine 131 to configure various aspects of clone virtual machine 131 at step 5. In some examples, a metadata file can be provided that can indicate addressing information associated with the virtual machine, resource availability of the virtual machine, packages to be provided to the virtual machine, or some other configuration information associated with clone virtual machine 131. Once configured using the metadata and powered on, clone virtual machine 131 can execute the desired function in the computing environment at step 6.

In at least one example, a host can employ multiple base or parent virtual machines that can be instant cloned for other virtual machines. The different base or parent virtual machines can include different software versions, different software packages, or some other different configuration. For example, a first base virtual machine can be associated with a first virtual disk file with a first version of a container orchestration platform, while a second base virtual machine can be associated with a second virtual disk file and a second version of the container orchestration platform. When an administrator requests that one or more virtual machines be initiated in the computing environment, a base virtual machine is selected with the requisite software configuration and used to deploy one or more clone virtual machines requested by the administrator.

In some examples, a base virtual machine may not be available to support a cluster request by an administrator. For example, administrator 310 may generate a request to deploy a cluster of virtual machines that require a first containerization platform. A check can be performed at the host to determine whether a base virtual machine has been initiated and paused in a standby state with the required software configuration. If a base virtual machine is available, then the base virtual machine can be used to deploy the requested one or more instant clones using the base virtual machine, wherein the instant clones can be deployed using metadata defining configuration information for the one or more virtual machines and guest customization operations. If a base virtual machine is not available on the host, a new base virtual machine can be initiated on the host. The new base virtual machine can include the requisite disks for the virtual machine and the initiation can be paused prior to executing the guest customization operations for the virtual machine. Once the base virtual machine is stopped prior to the guest customization operations, the one or more virtual machines desired by the administrator can be initiated as instant clones, wherein guest customization operations are executed for the one or more virtual machines using metadata configuration data for the one or more virtual machines. In another example, when a base virtual machine or parent virtual machine is not available to support the preferences of the administrator, virtual machines can be deployed without using instant clones to support the request. Thus, when a base or parent virtual machine is not available, full virtual machines with separate memory spaces can be deployed to support the request.

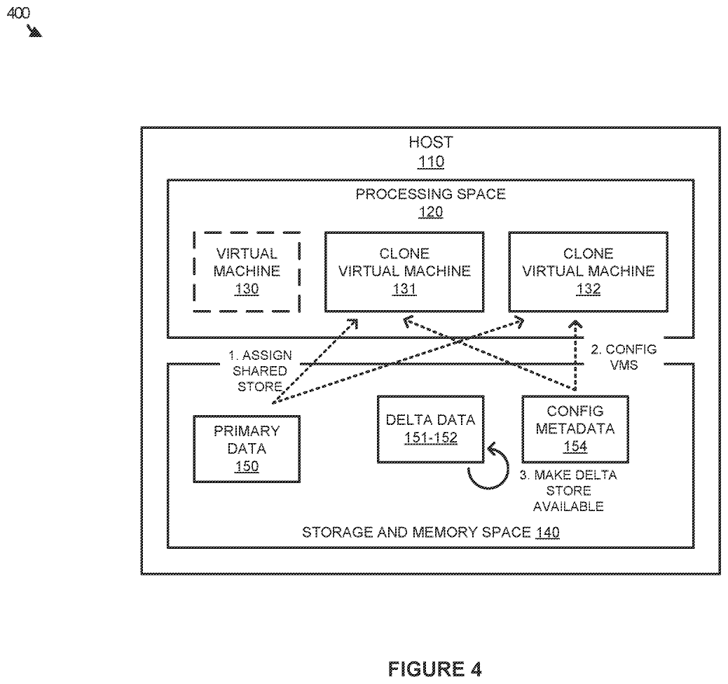

FIG. 4 illustrates an operational scenario 400 of deploying multiple guest virtual machines for a cluster according to an implementation. Operational scenario 400 includes systems and elements from computing environment 100 of FIG. 1. While demonstrated deploying two virtual machines to support the request, any number of virtual machines can be requested by an administrator on host 110.

In operational scenario 400, virtual machine 130 is representative of a base or parent virtual machine that can be cloned as one or more additional virtual machines on host 110. In at least one example, an administrator may trigger an initiation of virtual machine 130 by identify disks (i.e., disk files) that are to be made available to virtual machine 130. The disks can include an operating system, services, or other applications that are associated with virtual machine 130. For example, virtual machine 130 may be provided with a disk file that includes a container orchestration platform for containers that can be deployed on the virtual machine. Once the initiating is triggered, configuration operations are performed in association with virtual machine 130. The configuration operations can include attaching or mounting the select disks to the virtual machine, loading at least a portion of the data from the disk into memory or some other configuration operation. In operational scenario 400, the disk storage and memory for virtual machine 130 is represented as primary data 150. During the configuration of virtual machine 130, host 110 stops or freezes the configuration of virtual machine 130 prior to executing guest customization operations, which is representative of operations that can configure unique aspects of virtual machine 130. The guest customization operations can be used to obtain specific packages for the virtual machine, assign addressing information to the virtual machine, configure resources for the virtual machine (processing, memory, and the like), or provide some other configuration information in association with the virtual machine.

After the configuration of virtual machine 130 is stopped, an administrator can initiate a deployment of a cluster that uses multiple virtual machines derived from virtual machine 130. Here, an administrator requests that two clone virtual machines 131-132 be initiated from virtual machine 130. In response to the request, host 110 assigns, at step 1, primary data 150 to both cloned virtual machines 131-132. The primary data 150 comprises memory and disk space that is read-only for both clone virtual machines 131-132. Thus, rather than loading data into separate memory spaces, each clone virtual machine can read data from primary data 150 that was made available via virtual machine 130.

In addition to making primary data 150 available to clone virtual machines 131-132, host 110 further configures the virtual machines at step 2. Specifically, configuration operations can be resumed for clone virtual machines 131-132 where they were stopped for virtual machine 130, including the execution of guest customization operations. The configuration operations, including guest customization operations, can use configuration metadata 154 to configure the virtual machines 131-132. The metadata can be used to configure networking for clone virtual machines 131-132, define packages for clone virtual machines 131-132, define processor and memory resources for clone virtual machines 131-132, or provide some other configuration information in association with clone virtual machines 131-132. Additionally, host 110 can make delta data stores (delta data 151-152) available to clone virtual machines 131-132, wherein the delta data stores, or disks, are used to store data unique to the corresponding clone virtual machine. The unique data can include configuration information that is unique to the virtual machine, including addressing and host name information, can include data sets used by the clone virtual machine, repositories for the virtual machine, or some other information. Once the configuration operations are completed, clone virtual machines 131-132 can perform the desired cluster functionality. In at least one example, clone virtual machines 131-132 can provide a platform for containers that can support various applications for the administrator in a computing environment.

Although depicted in the example of FIG. 4 using a single base or parent virtual machines, some deployments can permit multiple base or parent virtual machines, wherein the different base virtual machines can comprise different software, different software versions, different disks, or some other different configuration. For example, a first base virtual machine, can be configured with a first disk (i.e., virtual disk file), while a second base virtual machine can be configured with a second disk. When an administrator generates a request for a new cluster that comprises one or more virtual machines, the user can indicate the software required for the new cluster and the appropriate disk image can be selected. Once selected, one or more instant clones of the base virtual machine are initiated using the guest customization operations described herein.

In at least one example, an administrator can request a cluster where there does not exist a base virtual machine to deploy the required instant clones. When this occurs, host 110 can initiate a new base virtual machine by initiating the configuration operations in association with the base virtual machine. Prior to executing guest customization operations the base virtual machine can be stopped or placed in a standby condition and the required one or more instant clone virtual machines can be initiated from this base virtual machine. Advantageously, when another cluster is requested or additional virtual machines are requested for the same cluster that use the same software as the base virtual machine, the new virtual machines can use the base virtual machine to efficiently deploy the required cluster.

In some examples, when there are multiple hosts in a computing environment, a management service, such as management service 102 in FIG. 1, can identify whether a host exists to support the requested cluster. The management service can determine whether a host includes a base virtual machine that includes the requisite software and can further determine whether a host exists that includes the requisite resources to support the cluster. If a host exists, the host can be selected for the cluster and the one or more instant clones can be deployed on the host. Otherwise, a new base virtual machine can be initiated on a host with available resources and the instant clones can be initiated by resuming the configuration operations including the guest customization operations.

In other examples, when a base virtual machine is not available to support a request, host 110 can initiate a full virtual machine without pausing the configuration prior to the guest customization operations. For example, if an administrator requested two virtual machines for a cluster and a base virtual machine is not available to support the request, host 110 can initiate two distinct virtual machines that do not share a common disk and memory space. Rather, each of the virtual machines can be allocated one or more disks and memory to support the desired functions of the administrator.

Although demonstrated as local to host 110, the metadata for configuring the clone virtual machines can be located on external systems. For example, the configuration. Further while demonstrated as a single metadata file, the metadata file can be distributed across multiple files to provide the desired configuration information for clone virtual machines 131-132.

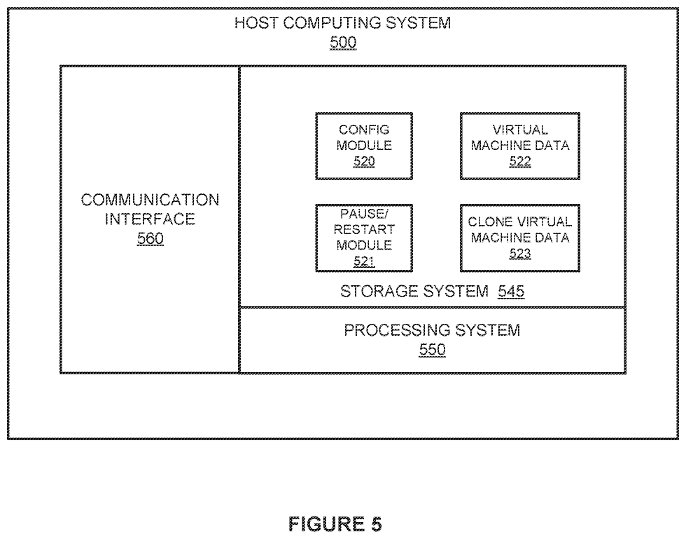

FIG. 5 illustrates a host computing system 500 to manage the deployment of a guest virtual machine according to an implementation. Host computing system 500 is representative of any computing system or systems with which the various operational architectures, processes, scenarios, and sequences disclosed herein for a management service. Management computing node can be implemented system 500 is an example of management service 115 of FIG. 1, although other examples may exist. Host computing system 500 includes storage system 545, processing system 550, and communication interface 560. Processing system 550 is operatively linked to communication interface 560 and storage system 545. Communication interface 560 may be communicatively linked to storage system 545 in some implementations. Host computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 may be configured to communicate with one or more hosts as part of a computing environment.

Processing system 550 comprises microprocessor and other circuitry that retrieves and executes operating software from storage system 545. Storage system 545 may include volatile and nonvolatile, removable, and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises configuration module 520 and pause restart module 521. The operating software on storage system 545 may further include an operating system, utilities, drivers, network interfaces, applications, or some other type of software. Here, storage system 545 further includes virtual machine data 522 for a base virtual machine and clone virtual machine data 523 that is representative of data unique to instant clones derived from the base virtual machine. When read and executed by processing system 550 the operating software on storage system 545 directs host computing system 500 to operate as a host described herein in FIG. 1-4.

In at least one implementation, configuration module 520 directs processing system 550 to receive a request to generate a first virtual machine, wherein the first virtual machine represents a parent or base virtual machine that can be used in association with one or more other virtual machines. In response to the request, configuration module 520 directs processing system 550 to initiate configuration operations in association with first virtual machine. The configuration operations can be used to mount one or more disks associated with the first virtual machine, load at least a portion of the data from the one or more disks into memory, or provide some other operation in association with the first virtual machine. Here, the data for the first virtual machine is represented as virtual machine data 522, wherein the data can be cached in a memory space for the first virtual machine and storage device (e.g., solid-state, hard disk, and the like). After executing a portion of the configuration operations, such as loading data into memory and mounting the required disk or disks, pause/restart module 521 directs processing system 550 to pause the configuration operations. The pausing of the operations can occur prior to or in response to detecting that the guest customization operations are going to be performed for the first virtual machine. The pausing of the configuration operations permits instant clones to be generated from the first virtual machine.

Once the first virtual machine is paused, host computing system 500 will wait for a request from an administrator to generate a guest cluster from the first virtual machine, wherein the guest cluster can comprise one or more virtual machines. In response to a request for a guest cluster, pause/restart module 521 directs processing system 550 to initiate one or more virtual machines to support the request, wherein the one or more virtual machines comprise instant clones of the first virtual machine. The instant clones each share the disks and the memory space for the first virtual machine and use the disk and memory as a read-only resource. Additionally, the one or more virtual machines are allocated a delta disk that is used to monitor for writes associated with the virtual machine. The delta disks are represented in host computing system 500 as clone virtual machine data 523.

When initiating the one or more clone virtual machines, pause/restart module 521 can direct processing system 550 to execute at least the guest customization operations for each of the one or more virtual machines. The guest customization operations can determine resources available to the virtual machine, packages required by the virtual machine, addressing information for the virtual machine, host name information, or some other configuration information for the virtual machine. By executing the guest customization operations at the time of deployment of the instant clones, the cluster can be configured as required for the deployment, including resources, packages, networking, and the like for the individual deployment.

Although demonstrated with a single base virtual machine in the example of host 500, any number of base virtual machines can be initiated and stopped prior to completing configuration. When a request is generated from an administrator, configuration module 520 can direct processing system 550 to identify a base virtual machine from a set of base virtual machines with the required configuration. Once identified, the host can initiate one or more virtual machines as instant clones of the identified base virtual machine. Accordingly, an administrator can deploy various base virtual machines that can include different software or versions to support different functions in a computing environment. Further, in some configurations, a computing environment can deploy multiple hosts, and a request from a management service can select a host based on the availability of a base virtual machine to support the request and resource availability on the host. Once a host is selected for the cluster, one or more virtual machines can be deployed on the host to support the request from the administrator.

Although demonstrated as receiving a request for an existing base virtual machine, an administrator can also request a cluster of virtual machines that does not have a base virtual machine or virtual machine paused prior to executing the guest customization operations. In these examples, configuration module 520 can direct processing system to initiate a new base virtual machine using disks identified from an administrator. Once the base virtual machine is available, the cluster of virtual machines can be deployed as instant clones of the first virtual machine and guest customization operations can be performed for each of the virtual machines. Advantageously, when a base virtual machine is available, the cluster can be deployed quickly from the base virtual machine. Otherwise, a base virtual machine can be initiated, and clone virtual machines can be initiated from the base. The base virtual machine can then be used in association with later requested clusters.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a host, the method comprising:
initiating startup operations of a first virtual machine;
stopping the startup operations prior to the first virtual machine executing guest customization operations;
in response to a request for a second virtual machine, initiating the second virtual machine as an instant clone of the first virtual machine; and
executing guest customization operations for the second virtual machine based on metadata provided for the second virtual machine, wherein the metadata provides configuration information for the second virtual machine.

2. The method of claim 1, wherein the configuration information comprises at least networking information for the second virtual machine.

3. The method of claim 2, wherein the networking information comprises at least an IP address and MAC address for the second virtual machine.

4. The method of claim 1, wherein the configuration information comprises resource requirements for the second virtual machine.

5. The method of claim 4, wherein the resource requirements comprise at least processor resources and memory resources.

6. The method of claim 1, wherein the request further requests a third virtual machine, and wherein the method further comprises:
in response to the request, initiating the virtual machine as an instant clone of the first virtual machine; and
executing the guest customization operations for the third virtual machine based on metadata provided for the third virtual machine, wherein the metadata provides configuration information for the third virtual machine.

7. The method of claim 1, wherein the configuration information for the second virtual machine and the configuration information for the third virtual machine configure the second virtual machine and third virtual machine as a cluster.

8. The method of claim 1, wherein the second virtual machine shares a memory space and disk with the first virtual machine.

9. The method of claim 1 further comprising allocating a delta disk to the second virtual machine.

10. A computing apparatus comprising:
a storage system;
a processing system operatively coupled to the storage system; and
program instructions stored on the storage system to operate a host that, when executed by the processing system, direct the computing apparatus to:
initiate startup operations of a first virtual machine;
stop the startup operations prior to the first virtual machine executing guest customization operations;
in response to a request for a second virtual machine, initiate the second virtual machine as an instant clone of the first virtual machine; and
execute the guest customization operations for the second virtual machine based on metadata provided for the second virtual machine, wherein the metadata provides configuration information for the second virtual machine.

11. The computing apparatus of claim 10, wherein the configuration information comprises at least networking information for the second virtual machine.

12. The computing apparatus of claim 11, wherein the networking information comprises at least an IP address and MAC address for the second virtual machine.

13. The computing apparatus of claim 10, wherein the configuration information comprises resource requirements for the second virtual machine.

14. The computing apparatus of claim 13, wherein the resource requirements comprise at least processor resources and memory resources.

15. The computing apparatus of claim 10, wherein the request further requests a third virtual machine, and wherein the program instructions further direct the computing apparatus to:
in response to the request, initiate the virtual machine as an instant clone of the first virtual machine; and
execute the guest customization operations for the third virtual machine based on metadata provided for the third virtual machine, wherein the metadata provides configuration information for the third virtual machine.

16. The computing apparatus of claim 10, wherein the configuration information for the second virtual machine and the configuration information for the third virtual machine configure the second virtual machine and third virtual machine as a cluster.

17. The computing apparatus of claim 10, wherein the second virtual machine shares a memory space and disk with the first virtual machine.

18. The computing apparatus of claim 10, wherein the program instructions further direct the computing apparatus to allocate a delta disk to the second virtual machine.

19. An apparatus comprising:
one or more non-transitory computer readable storage media; and
program instructions stored on the one or more non-transitory computer readable storage media that, when executed by a processing system, direct the processing system to:
initiate startup operations of a first virtual machine;
stop the startup operations prior to the first virtual machine executing guest customization operations;
in response to a request for a second virtual machine, initiate the second virtual machine as an instant clone of the first virtual machine; and
execute the guest customization operations for the second virtual machine based on metadata provided for the second virtual machine, wherein the metadata provides configuration information for the second virtual machine.

20. The computing apparatus of claim 10, the second virtual machine shares a memory space and disk with the first virtual machine, and wherein the program instructions further direct the processing system to allocate a delta disk to the second virtual machine.
